(19) United States
(12) Patent Application Publication
(10) Pub. No.: US 2023/0221191 A1
(43) Pub. Date: Jul. 13, 2023

(54) TEMPERATURE SENSING DEVICE AND CALIBRATION METHOD THEREOF

(71) Applicant: DigWise Technology Corporation, LTD, Hsinchu County (TW)

(72) Inventors: Wen-Pin HSIEH, Hsinchu County (TW); Yu-Chieh HUNG, Hsinchu County (TW); Chih-Wen YANG, Hsinchu County (TW)

(21) Appl. No.: 18/062,022

(22) Filed: Dec. 6, 2022

(30) Foreign Application Priority Data
Jan. 12, 2022 (TW) 111101285

(51) Int. Cl. G01K 15/00; G01K 7/22

(52) U.S. Cl. CPC G01K 15/005; G01K 7/22

(57) ABSTRACT

The present disclosure provides a temperature sensing device and a calibration method thereof. The temperature sensing device includes a current generation circuit, an analog-to-digital conversion (ADC) circuit and a processing circuit. The calibration method includes: by the current generation circuit, generating a temperature dependent current according to a temperature of a tested object, wherein the temperature dependent current is dependent on a reference current passing through an adjustable resistor of the current generation circuit; by the ADC circuit, performing an analog-to-digital conversion according to the temperature dependent current to generate a sensing value; by the processing circuit, comparing the sensing value with an ideal value; and by the processing circuit, adjusting a resistance value of the adjustable resistor according to a comparison result of the sensing value and the ideal value, so that the sensing value equals the ideal value.

### CROSS REFERENCE TO RELATED APPLICATION

This application claims priority to Taiwan Application Serial Number 111101285, filed Jan. 12, 2022, which is herein incorporated by reference in its entirety.

### BACKGROUND

### Field of Invention

This disclosure relates to a temperature sensing device and calibration method thereof, and in particular to a smart temperature sensing device and calibration method thereof.

### Description of Related Art

Existing temperature sensor senses temperature through BJT (bipolar junction transistor) therein. However, a voltage difference between a base terminal and an emitter terminal of the BJT often has error due to the influence of manufacturing process or package, and thereby the temperature sensor outputs wrong numeral value.

A well-known solution is to measure a change of the voltage difference and to compensate the change of the voltage difference, so as to decrease the error generated due to the influence of manufacturing process or package. However, it is inconvenient for the user to measure the change of the voltage difference.

### SUMMARY

An aspect of present disclosure relates to a temperature sensing device. The temperature sensing device includes a current generation circuit, an analog-to-digital conversion (ADC) circuit and a processing circuit. The current generation circuit is configured to generate a temperature dependent current according to a temperature of a tested object and includes an amplifier and an adjustable resistor, wherein the adjustable resistor and a negative input terminal of the amplifier are coupled to a first node. The ADC circuit is configured to perform an analog-to-digital conversion according to the temperature dependent current to generate a sensing value. The processing circuit is configured to compare the sensing value with an ideal value and is configured to adjust a resistance value of the adjustable resistor according to a comparison result of the sensing value and the ideal value, so that the sensing value equals the ideal value.

Another aspect of present disclosure relates to a calibration method of a temperature sensing device. The calibration method includes: by a current generation circuit, generating a temperature dependent current according to a temperature of a tested object, wherein the current generation circuit includes an adjustable resistor, and the temperature dependent current is dependent on a reference current passing through the adjustable resistor; by an analog-to-digital conversion (ADC) circuit, performing an analog-to-digital conversion according to the temperature dependent current to generate a sensing value; by a processing circuit, comparing the sensing value with an ideal value; and by the processing circuit, adjusting a resistance value of the adjustable resistor according to a comparison result of the sensing value and the ideal value, so that the sensing value equals the ideal value.

### BRIEF DESCRIPTION OF THE DRAWINGS

FIG. 1 is a schematic diagram of a temperature sensing device in accordance with some embodiments of the present disclosure;

FIG. 2 is a circuit diagram of a current generation circuit in accordance with some embodiments of the present disclosure;

FIG. 3 is a circuit diagram of a current generation circuit in accordance with some embodiments of the present disclosure; and

FIG. 4 is a flow diagram of a calibration method of temperature sensing device in accordance with some embodiments of the present disclosure.

### DETAILED DESCRIPTION

The embodiments are described in detail below with reference to the appended drawings to better understand the aspects of the present disclosure. However, the provided embodiments are not intended to limit the scope of the disclosure, and the description of the structural operation is not intended to limit the order in which they are performed. Any device that has been recombined by components and produces an equivalent function is within the scope covered by the disclosure.

The terms used in the entire specification and the scope of the patent application, unless otherwise specified, generally have the ordinary meaning of each term used in the field, the content disclosed herein, and the particular content.

The terms “coupled” or “connected” as used herein may mean that two or more elements are directly in physical or electrical contact, or are indirectly in physical or electrical contact with each other. It can also mean that two or more elements interact with each other.

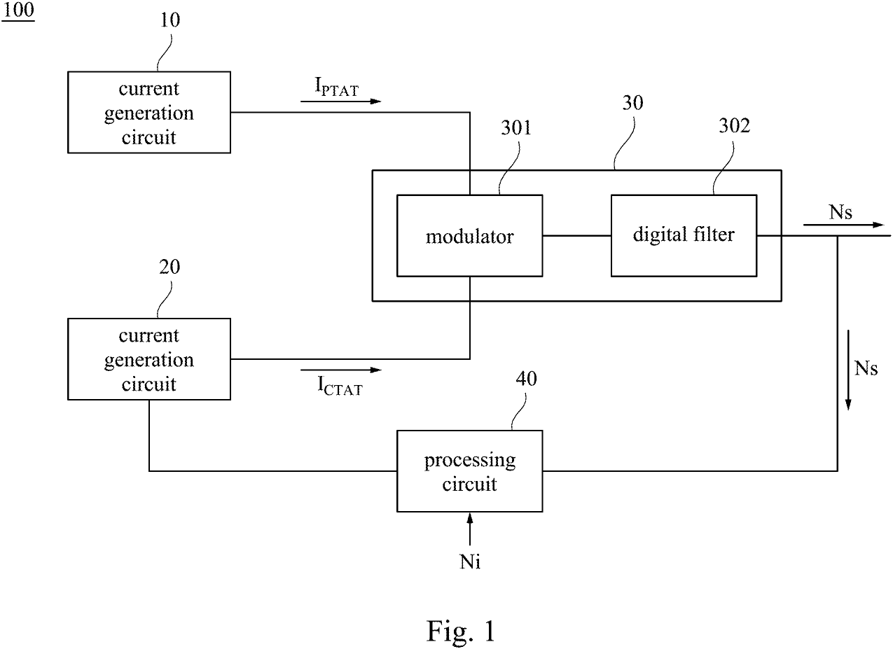

Referring to FIG. 1, FIG. 1 is a block diagram of a temperature sensing device 100 in accordance with some embodiments of the present disclosure. In some embodiments, the temperature sensing device 100 includes a current generation circuit 10, a current generation circuit 20, an analog-to-digital conversion (ADC) circuit 30 and a processing circuit 120. In some practical applications, the temperature sensing device 100 can be applied to an electronic device (e.g., computer) and is configured to monitor the temperature of components (e.g., microprocessor) inside the electronic device.

As shown in FIG. 1, both the current generation circuits 10 and 20 are coupled to the ADC circuit 30, and the processing circuit 40 is coupled between the ADC circuit 30 and the current generation circuit 20.

The ADC circuit 30 includes a modulator 301 and a digital filter 302. In some embodiments, the modulator 301 can be implemented by sigma-delta modulator, and the digital filter 302 can be implemented by decimation filter.

The current generation circuit 10 is configured to generate a current I_{PTAT}, which is proportional to absolute temperature, according to the temperature of a tested object (e.g., the microprocessor). In other words, the current I_{PTAT} is proportional to the temperature change. For example, the current I_{PTAT} increases with increasing temperature and decreases with decreasing temperature. It can be appreciated that the current generation circuit 10 can be implemented by the structure which is familiar to person having ordinary skill in the art of the present disclosure, and therefore the descriptions thereof are omitted herein.

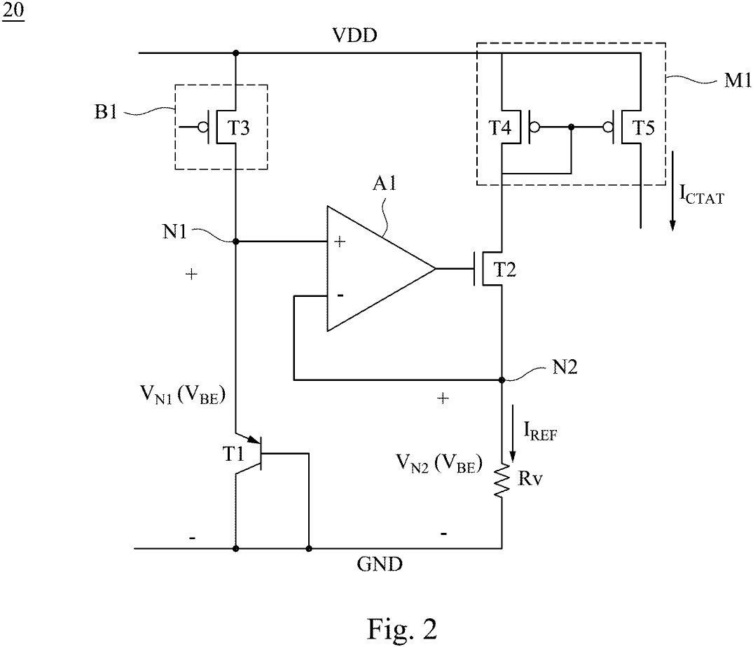

The current generation circuit 20 is configured to generate a current I_{CTAT}, which is complementary to absolute temperature, according to the temperature of the tested object. In other words, the current I_{CTAT} is inversely proportional to the temperature change. For example, the current I_{CTAT} decreases with increasing temperature and increases with decreasing temperature. The structure of the current generation circuit 20 would be described below with reference to FIG. 2.

Referring to FIG. 2, FIG. 2 is a circuit diagram of the current generation circuit 20 in accordance with some embodiments of the present disclosure. In some embodiments, the current generation circuit 20 includes an amplifier A1, a first transistor T1, a second transistor T2, an adjustable resistor Rv, a bias circuit B1 and a current mirror circuit M1. In structure, a first terminal (e.g., emitter) of the first transistor T1 and a positive input terminal (+) of the amplifier A1 are coupled to a node N1 (i.e., a second node). A second terminal (e.g., collector) and a control terminal (e.g., base) of the first transistor T1 are coupled to a ground terminal GND.

The bias circuit B1 is coupled between a power terminal VDD and the node N1 and is configured to provide a bias current (not shown) to the transistor T1. In some embodiments, the bias circuit B1 can be implemented by a transistor T3. In particular, a first terminal (e.g., source) of the transistor T3 is coupled to the power terminal VDD, a second terminal (e.g., drain) of the transistor T3 is coupled to the node N1, and a control terminal (e.g., gate) of the transistor T3 receives a bias voltage (not shown).

One terminal of the adjustable resistor Rv and a negative input terminal of the amplifier A1 are coupled to a node N2 (i.e., a first node), and another terminal of the adjustable resistor Rv is coupled to the ground terminal GND. A first terminal (e.g., source) of the second transistor T2 is coupled to the node N2, and a control terminal (e.g., gate) of the second transistor T2 is coupled to a output terminal of the amplifier A1. In addition, a second terminal (e.g., drain) of the second transistor T2 is coupled to the current mirror circuit M1.

The current mirror circuit M1 can be implemented by two transistors T4 and T5. In particular, a first terminal (e.g., source) of the transistor T4 is coupled to the power terminal VDD, and a second terminal (e.g., drain) and a control terminal (e.g., gate) of the transistor T4 and a control terminal (e.g., gate) of the transistor T5 are all coupled to the second terminal of the second transistor T2. In addition, a first terminal (e.g., source) of the transistor T5 is coupled to the power terminal VDD, and a second terminal (e.g., drain) of the transistor T5 is coupled to the ADC circuit 30 of FIG. 1 to output the current I_{PTAT} to the ADC circuit 30.

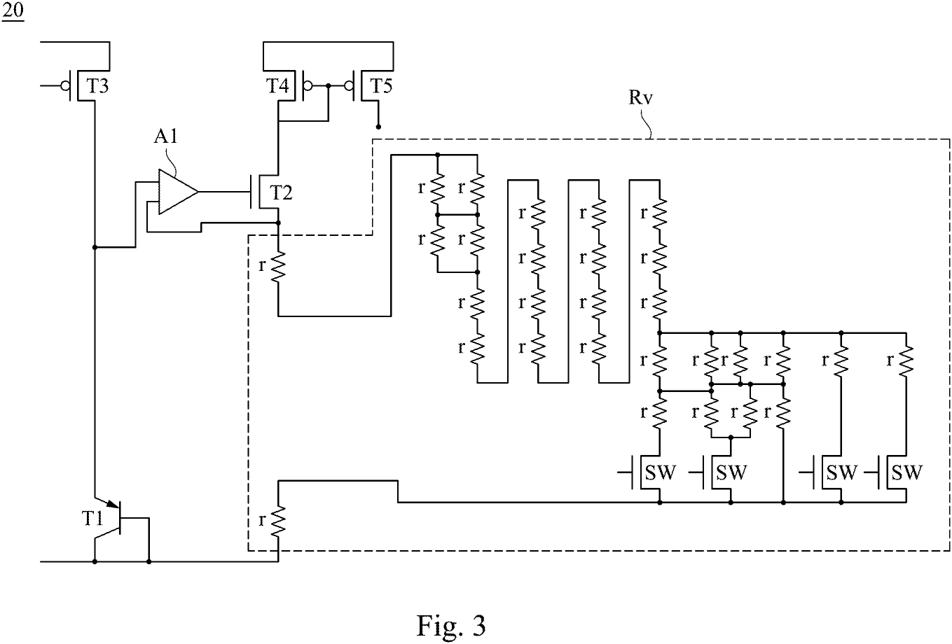

Referring to FIG. 3, FIG. 3 is a circuit diagram of the current generation circuit 20 in accordance with some embodiments of the present disclosure. In some embodiments, the adjustable resistor Rv includes a plurality of resistors r and a plurality of switching elements SW. The processing circuit 40 of FIG. 1 can be coupled to the switching elements SW and can adjust a series-parallel combination of the resistors r by controlling the switching elements SW, to adjust a resistance value of the adjustable resistor Rv. It can be appreciated that the resistance of the resistors r can be all same or all different, or can be part same, part different. In addition, the switching elements SW can be implemented by transistor.

In a general operation of the temperature sensing device 100, the first transistor T1 is biased via the bias current generated by the bias circuit B1, so that a voltage V_{N1} is formed between the node N1 and the ground terminal GND. In the embodiment of FIG. 2, the voltage V_{N1} is a voltage difference V_{BE} between the first terminal and the control terminal of the first transistor T1. In some embodiments, the magnitude of the voltage difference V_{BE} can be determined according to the temperature of the tested object. In particular, the voltage difference V_{BE} of the first transistor T1 is inversely proportional to the temperature change. For example, the voltage difference V_{BE} decreases with increasing temperature and increases with decreasing temperature.

The amplifier A1 controls a voltage V_{N2} of the node N2 to the voltage (i.e., the voltage difference V_{BE} of the first transistor T1) same as the voltage V_{N1} of the node N1 by negative feedback formed via the second transistor T2. In other words, the voltage difference V_{BE} of the first transistor T1 is applied to the adjustable resistor Rv, to generate a reference current I_{REF}. It can be seen from above descriptions that the reference current I_{REF} is the voltage difference V_{BE} of the first transistor T1 divided by the resistance value of the adjustable resistor Rv.

As shown in FIG. 2, the reference current I_{REF} would pass through the transistor T4 of the current mirror circuit M1, the second transistor T2 and the adjustable resistor Rv. In such way, the current mirror circuit M1 can generate the current I_{CTAT} according to the reference current I_{REF}. In some embodiments, the transistor T4 and the transistor T5 are fabricated in same manufacturing process and are similar in size. Accordingly, the current I_{CTAT} and the reference current I_{REF} are substantially same as each other (that is, the current I_{CTAT} is also the voltage difference V_{BE} of the first transistor T1 divided by the resistance value of the adjustable resistor Rv).

It can be seen from above descriptions that since the voltage difference V_{BE} of the first transistor T1 is inversely proportional to the temperature change, the current I_{CTAT} is also inversely proportional to the temperature change.

It can be appreciated that the process that the current generation circuit 10 generates the current I_{PTAT} proportional to the temperature change is familiar to person having ordinary skill in the art of the present disclosure, and therefore the descriptions thereof are omitted herein.

In some embodiments, as the embodiment of FIG. 1, the ADC circuit 30 performs an analog-to-digital conversion according to the current I_{PTAT} and the current I_{CTAT} which are dependent on the temperature, to generate a sensing value Ns corresponding to the temperature of the tested object. In some practical applications, the sensing value Ns is integer (e.g., 253-258), and different sensing value Ns corresponds to different temperature (e.g., Celsius (°C)).

In the aforementioned general operation, the tested object of the temperature sensing device 100 is usually expected to be at an ideal temperature. Therefore, the temperature sensing device 100 is expected to output an ideal value (e.g., symbol “Ni” in FIG. 1) corresponding to the ideal temperature. However, the voltage difference V_{BE} of the first transistor T1 practically would generate error due to the influence of manufacturing process or package, and the error of the voltage difference V_{BE} further affects the current I_{CTAT}, so that the temperature sensing device 100 might output a numeral value different from the ideal value (that is, the sensing value Ns outputted by the ADC circuit 30 is different from the ideal value).

In some embodiments, the temperature sensing device 100 solves the error problem by a calibration operation. In the calibration operation, as shown in FIG. 1, the processing circuit 40 is configured to compare the sensing value Ns outputted by the ADC circuit 30 with the ideal value Ni and is configured to modify the current I_{CTAT} outputted by the current generation circuit 20 according to a comparison result of the sensing value Ns and the ideal value Ni, so that the sensing value Ns equals the ideal value Ni.

In particular, the processing circuit 40 is configured to adjust the resistance value of the adjustable resistor Rv as shown in FIGS. 2 or 3 according to the comparison result of the sensing value Ns and the ideal vale Ni, to modify the current I_{CTAT} outputted by the current generation circuit 20. For example, if the sensing value Ns (e.g., 258) is greater than the ideal value Ni (e.g., 256), it represents that the current I_{CTAT} may be increased due to the influence of the error. Accordingly, the processing circuit 40 can decrease the current I_{CTAT} by increasing the resistance value of the adjustable resistor Rv, so that the sensing value Ns equals the ideal value Ni. Reversely, if the sensing value Ns (e.g., 253) is smaller than the ideal value Ni (e.g., 256), it represents that the current I_{CTAT} may be decreased due to the influence of the error. Accordingly, the processing circuit 40 can increase the current I_{CTAT} by decreasing the resistance value of the adjustable resistor Rv, so that the sensing value Ns equals the ideal value Ni.

In the above embodiments, the first transistor T1 can be implemented by PNP type bipolar junction transistor, the second transistor T2 can be implemented by N type metal oxide semiconductor transistor, and the transistors T3-T5 can be implemented by P type metal oxide semiconductor transistor. However, the present disclosure is not limited herein.

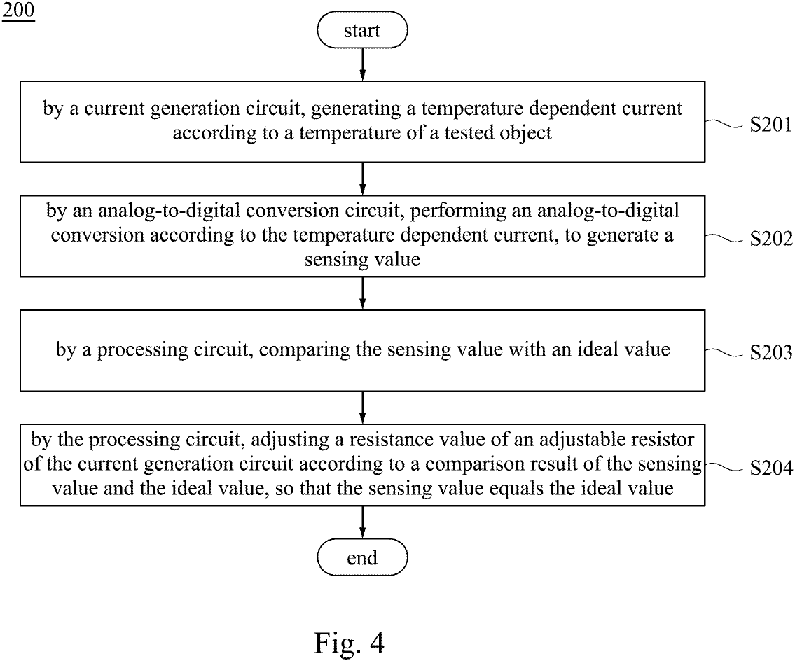

Referring to FIG. 4, FIG. 4 is a flow diagram of a calibration method 200 of the temperature sensing device in accordance with some embodiments of the present disclosure. The calibration method 200 can be executed by the temperature sensing device 100 of FIG. 1, but the present disclosure is not limited herein. The calibration method 200 includes steps S201-S204. For convenience of description, the calibration method 200 would be described below with reference to FIGS. 1-3.

In step S201, a current generation circuit generates a temperature dependent current according to a temperature of a tested object. For example, the current generation circuit 20 of FIGS. 1 or 2 generates the current I_{CTAT} (i.e., the temperature dependent current) complementary to absolute temperature according to the temperature of the microprocessor of the computer (for example but not limited to).

In some embodiments, as the embodiment of FIG. 2, the current I_{CTAT} is generated according to the reference current I_{REF} which passes through the transistor T4 of the current mirror circuit M1, the second transistor T2 and the adjustable resistor Rv, and therefore the current I_{CTAT} is dependent on reference current I_{REF}. The generation of the reference current I_{REF} is same or similar to those of above embodiments, and therefore the descriptions thereof are omitted herein.

In step S202, an analog-to-digital conversion (ADC) circuit performs an analog-to-digital conversion according to the temperature dependent current to generate a sensing value. In some embodiments, as the embodiment of FIG. 1, the ADC circuit 30 performs the analog-to-digital conversion according to the current I_{CTAT} generated by the current generation circuit 20 to generate the sensing value Ns.

In step S203, the sensing value is compared with an ideal value. In some embodiments, as the embodiment of FIG. 1, the processing circuit 40 compares the sensing value Ns generated by the ADC circuit 30 with the ideal value Ni.

In step S204, a resistance value of an adjustable resistor in the current generation circuit is adjusted according to a comparison result of the sensing value and the ideal value, so that the sensing value equals the ideal value. In some embodiments, as the embodiment of FIGS. 1, 2 or 3, the processing circuit 40 adjusts the resistance value of the adjustable resistor Rv according to the comparison result of the sensing value Ns and the ideal value Ni, so that the sensing value Ns equals the ideal value Ni.

The descriptions of steps S201-S204 are same or similar to those of the aforementioned embodiments, and therefore are not described herein.

It can be seen from the above embodiments of the present disclosure, the temperature sensing device 100 and the calibration method 200 of the present disclosure directly compares the sensing value Ns with the ideal value Ni and adjust the adjustable resistor Rv in the current generation circuit 20 according to the comparison result, so that sensing value Ns equals the ideal value Ni. In comparison with well-known technology, the temperature sensing device 100 and the calibration method 200 of the present disclosure do not need to measure the change of the voltage difference between the base terminal and the emitter terminal of bipolar junction transistor. Therefore, it is more convenient for the user to operate.

Although the present disclosure has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present disclosure without departing from the scope or spirit of the invention. In view of the foregoing, it is intended that the present invention cover modifications and variations of this invention provided they fall within the scope of the following claims.

What is claimed is:

1. A temperature sensing device, comprising:
a current generation circuit configured to generate a temperature dependent current according to a temperature of a tested object and comprising an amplifier and an adjustable resistor, wherein the adjustable resistor and a negative input terminal of the amplifier are coupled to a first node;
an analog-to-digital conversion (ADC) circuit configured to perform an analog-to-digital conversion according to the temperature dependent current to generate a sensing value; and
a processing circuit configured to compare the sensing value with an ideal value and configured to adjust a resistance value of the adjustable resistor according to a comparison result of the sensing value and the ideal value, so that the sensing value equals the ideal value.

2. The temperature sensing device of claim 1, wherein the current generation circuit further comprises:
a first transistor, wherein a first terminal of the first transistor and a positive input terminal of the amplifier are coupled to a second node, and a second terminal and a control terminal of the first transistor are coupled to a ground terminal;
a bias circuit coupled to the second node and configured to provide a bias current to the first transistor;
a second transistor, wherein a first terminal of the second transistor is coupled to the first node, and a control terminal of the second transistor is coupled to an output terminal of the amplifier; and
a current mirror circuit coupled to a second terminal of the second transistor and configured to generate the temperature dependent current according to a reference current passing through the second transistor and the adjustable resistor.

3. The temperature sensing device of claim 2, wherein the temperature dependent current is a voltage difference between the first terminal and the control terminal of the first transistor divided by the resistance value of the adjustable resistor.

4. The temperature sensing device of claim 3, wherein the voltage difference is inversely proportional to a temperature change.

5. The temperature sensing device of claim 2, wherein the first transistor is a bipolar junction transistor, and the second transistor is a metal oxide semiconductor transistor.

6. The temperature sensing device of claim 1, wherein the temperature dependent current is a current complementary to absolute temperature.

7. The temperature sensing device of claim 1, wherein the adjustable resistor comprises a plurality of resistors and a plurality of switching elements, and the processing circuit is configured to adjust a series-parallel combination of the plurality of resistors by controlling the plurality of switching elements, to adjust the resistance value of the adjustable resistor.

8. A calibration method of a temperature sensing device, comprising:
by a current generation circuit, generating a temperature dependent current according to a temperature of a tested object, wherein the current generation circuit comprises an adjustable resistor, and the temperature dependent current is dependent on a reference current passing through the adjustable resistor;
by an analog-to-digital conversion (ADC) circuit, performing an analog-to-digital conversion according to the temperature dependent current to generate a sensing value;
by a processing circuit, comparing the sensing value with an ideal value; and
by the processing circuit, adjusting a resistance value of the adjustable resistor according to a comparison result of the sensing value and the ideal value, so that the sensing value equals the ideal value.

9. The calibration method of claim 8, wherein the current generation circuit further comprises an amplifier, a first transistor, a second transistor and a current mirror circuit, and generating the temperature dependent current comprises:
by the amplifier and the second transistor, applying a voltage difference between a first terminal and a control terminal of the first transistor to the adjustable resistor to generate the reference current; and
by the current mirror circuit, generating the temperature dependent current according to the reference current.

10. The calibration method of claim 9, wherein the temperature dependent current is the voltage difference between the first terminal and the control terminal of the first transistor divided by the resistance value of the adjustable resistor.

11. The calibration method of claim 10, wherein the voltage difference is inversely proportional to a temperature change.

12. The calibration method of claim 9, wherein the first transistor is a bipolar junction transistor, and the second transistor is a metal oxide semiconductor transistor.

13. The calibration method of claim 8, wherein the temperature dependent current is a current complementary to absolute temperature.

14. The calibration method of claim 8, wherein if the sensing value is greater than the ideal value, the processing circuit increases the resistance value of the adjustable resistor.

15. The calibration method of claim 8, wherein if the sensing value is smaller than the ideal value, the processing circuit decreases the resistance value of the adjustable resistor.
